(19) United States
(12) Patent Application Publication
(10) Pub. No.: US 2008/0147773 A1
(43) Pub. Date: Jun. 19, 2008

(54) RATINGS SYSTEMS VIA MOBILE COMMUNICATIONS DEVICES

(75) Inventor: Jeffrey Aaron, Atlanta, GA (US)

Correspondence Address: WITHERS & KEYS FOR BELL SOUTH, P. O. BOX 71355, MARIETTA, GA, 30007-1355, US

(73) Assignee: BellSouth Intellectual Property Corp.

(21) Appl. No.: 11/610,890

(22) Filed: Dec. 14, 2006

(51) Int. Cl. G06F 15/16

(52) U.S. Cl. 709/201

(57) ABSTRACT

A mobile communications device may be used to create and/or receive user ratings of items. A rating may be provided for an item by the user of the mobile communications device or a rating for the item may be obtained and provided to the user in response to the mobile communications device coming into physical proximity to the item, such as when the user is purchasing or making use of the item, or at a later time after the mobile communications device is no longer in physical proximity to the item. The physical proximity is used to inform an external system of the item that is relevant to the user and for which a rating is being provided or for which a rating is requested by the user. The physical proximity to the item may be recognized by the mobile communications device providing its current location to the external system or by the mobile communications device providing an identifier of the item to the external system.

### TECHNICAL FIELD

Embodiments are related to ratings systems for items including goods, services, establishments, locales, scenic views, hiking trails, and the like. More particularly, embodiments are related to interaction of ratings systems with mobile communications devices.

### BACKGROUND

Rating systems are useful to consumers wishing to purchase goods or services, or to utilize offerings such as parks, trails, and other facilities. Ratings posted by other consumers for an item allow a potential consumer to gain insight about the item prior to actually purchasing and using it, or prior to choosing whether to utilize a park, trail, or other offering. Thus, consumers may be more inclined to purchase items and utilize facilities with generally good ratings while consumers may be reluctant to purchase items or utilize facilities with generally poor ratings.

Such rating systems are becoming commonplace for retail web sites on the Internet. Users who visit a particular web site are provided with options to view ratings that other consumers have provided about an item and options to provide their own rating about the item. Ratings systems for brick and mortar locations, such as where items are for sale or are in use, are generally not available to consumers in a convenient manner, and at best may exist for a set of locations, for instance in the form of overall ratings for store chains taken as a whole, as may be found in certain consumer-oriented magazines. Therefore, consumers do not benefit from such ratings systems for specific physical locations encountered by the consumers.

### SUMMARY

Embodiments address these issues and others by providing interaction of mobile communications devices such as cellular telephones, personal daily assistants, and the like with interaction with ratings systems. The basis for providing or receiving ratings of items is the physical proximity of the mobile communications device to the item such that as the consumer encounters items during daily travels, the consumer may view and provide ratings for those encountered items, either at the time of the encounter or at some later time. Items rated may include, but are not be limited to, products, aspects/features/characteristics of a product, services, aspects/features/characteristics of a service, locations, aspects/features/characteristics of a location, facilities, aspects/features/characteristics of a facility, and any other definable items associated with or associable with a particular location.

Embodiments provide a mobile communications device that includes an output device, an input device, and a wireless transceiver. The mobile communications device further includes a ratings relevance device that obtains ratings relevance information relevant to an item that is in physical proximity to the mobile communications device at the time the ratings relevance information is obtained. The mobile communications device also includes a processor configured to provide to an external system with the ratings relevance information of the mobile communications device via the wireless transceiver, receive in response to providing the relevance information a request for a rating of the item that is relevant to the relevance information via the wireless transceiver, provide the request via the output device, receive a rating via the input device in response to providing the request, and send the rating via the wireless transceiver to the external system.

Embodiments further provide a method of utilizing ratings of items. The method involves accepting by a mobile communications device ratings relevance information relevant to an item at a time when the mobile communications device is in physical proximity to the item. The method further involves transmitting by the mobile communications device the ratings relevance information to an external system. In response to transmitting the ratings relevance information, the mobile communications device receives from the external system a rating for the item.

Embodiments also provide a computer readable medium having instructions that perform acts including obtaining by a mobile communications device ratings relevance information relevant to an item at a time when the mobile communications device is in physical proximity to the item. The acts further include providing to an external system the ratings relevance information from the mobile communications device, receiving at the mobile communications device in response to providing the relevance information a request for a rating of the item that is relevant to the ratings relevance information, and providing the request on an output device of the mobile communications device. Additionally, the acts include accepting a rating via an input device of the mobile communications device in response to providing the request, sending the rating from the mobile communications device to the external system, in response to transmitting the ratings relevance information, further receiving at the mobile communication device a rating for the item from the external system, and providing the rating at the mobile communication device.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

FIG. 1 shows one example of a mobile communications system including a ratings system for interaction with mobile communications devices.

FIG. 2 shows one example of a mobile communications device that interacts with the ratings system.

FIG. 3 shows one example of a ratings system that interacts with the mobile communications device.

FIGS. 4A-4E show one example of the logical operations of the mobile communications device to interact with the ratings system.

FIG. 5 shows on example of the logical operations of the ratings system to interact with the mobile communications device.

### DETAILED DESCRIPTION

Exemplary embodiments provide consumers with the ability to provide or receive ratings via mobile communications devices. The ratings being provided or received are correlated with the physical locations that the mobile communications device encounters. Accordingly, the user of the mobile communications device benefits from such ratings systems during daily experiences with items including goods and services.

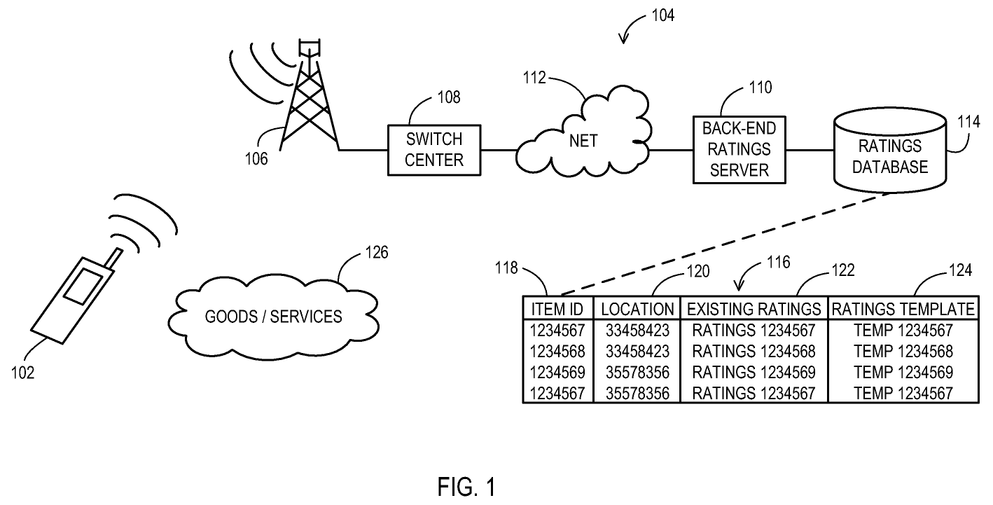

FIG. 1 shows an example of a mobile communications network 104 offering a ratings service to users of mobile communications devices 102. During conventional uses of the mobile communications device 102, wireless signals are exchanged between the mobile communications device 102 and a base station 106 or other wireless end point. The base station interfaces to the mobile communications network 104 via a switching center 108. The switching center 108 may be interfaced to a core mobile network, a wireline telephone network, a data network, and the like. In the example shown, the switching center 108 is in communications with a ratings server 110 via a data network 112, such as the Internet or an Intranet utilizing one of a variety of data exchange protocols such as TCP/IP. The mobile communications device 102 may also interface with other mobile communications devices, such as via direct peer-to-peer connectivity and/or via communications through the mobile communications network.

The ratings server 110 may be a component of the mobile communications system 104 as operated by the mobile communications service provider. As one alternative, the ratings server 110 may be operated by a third party ratings service. As another alternative, the ratings server 110 may be operated by a merchant of goods and services for which the ratings apply. The ratings server 110 has access to a database 114 which maintains associations of items to ratings data as shown in table 116.

As shown in table 116, an item may have an item ID 118, a location 120, a data file 122 containing a collection of existing ratings, and a data file 124 containing a ratings template. The item ID 118 and location ID 120 are examples of ratings relevance data in that they are used to identify the relevant item for which ratings data is desired.

The item ID 118 may be a number that in some manner uniquely identifies a good or service 126. For example, the item ID 118 may be a UPC code where that code is found in a bar code or radio frequency identification (RFID) tag located on the item 126. UPC codes are commonly used to uniquely identify a type of product, for instance a particular kind of shoe, whereas RFID tags are even capable of uniquely identifying an instance of a type of product, such as a particular pair of a certain kind of shoes. As discussed below the item ID 118 may be used to identify which good or service a mobile communication device is referencing when requesting an existing rating or rating template. When the mobile communications device 102 comes into physical proximity of the good or service that has an item ID, an embodiment of the mobile communications device 102 that is equipped with an item ID scanner such as a bar code scanner or RFID reader may obtain the item ID and provide the ID in a request to the rating server 11O.

The location 120 is an identification of where the item 126 is located. The location 120 may be specified in terms of latitude and longitude or some other scheme of positioning and may also specify an elevation in order to more precisely identify where the item 126 is located. For instance, elevation data may allow the specification of a particular floor in a multi-level department store. According to some embodiments, the mobile communications device 102 may obtain its own location via an on-board geonavigational positioning system receiver, an on-board cellular signal triangulation, or other device for detecting location. Any suitable means of determining location may be used. The mobile communications device 102 may then include the location in the request to the ratings server 110. The ratings server 110 may find the appropriate item based on finding the nearest matching location within the table 116 which meets a minimum distance criteria. If the minimum distance criteria are not met, then a “no match” error may result, or a new item may be entered into the table.

As discussed below, a single location may have multiple items 126 for which ratings can be provided by the user or can be provided to the user. In that case, if the mobile communications device 102 has not provided an item ID to precisely identify the item of interest but has instead only provided the location, or if some ambiguity of items exists for any other reason, then the ratings server 110 may respond to the request by providing the requested ratings data, i.e., existing ratings 122 or the ratings template 124, for each of the items that match. The mobile communications device 102 may then employ a manner of eliminating those items not of interest such as by applying filters set by the user, applying a match from a list of previously requested ratings, and/or may display or otherwise provide an output listing all items for which data is received in a list to allow the user to choose the match. Rather than having the mobile communications device 102 perform the match, the ratings server 110 may instead apply one of these techniques for finding the match.

The existing ratings data 122 may provide individual ratings, statistics, opinions, summaries, other calculated results, etc. for items. Individual ratings may be given on a scale such as numerical or alphabetical, or in some reasonable combination. The individual ratings may include a listing of the most recently provided ratings such as where the number of individual ratings are too numerous to display or otherwise output. The ratings data 122 may be transferred to the mobile communications device 102 where it can be formatted for display on the display screen or for another mode of output. Visual display of multiple ratings may be in any suitable manner, for instance via lists, tables, pie charts, bar charts, 2D graphs, 3D perspective graphs, moving displays, etc. Other alternatives include providing an audio rendition of the ratings rather than visual.

The ratings template data 124 may provide a template for receiving data from the mobile communications device 102. The template may specify a visual display with graphical user interface features such as check boxes to select the rating, drop down menus to receive a selection from a rating scale, and text fields for receiving textual entry of the rating and/or opinions.

As shown in table 116, multiple items IDs may correspond to the same location such as where the items are in close proximity at the same merchant. Likewise, the same item ID may correspond to multiple locations, such as where multiple merchants carry the same type of item. Where item IDs also specify unique instances of types of items, these IDs may in some cases be processed so that the processed IDs correspond only to unique types of items, i.e. removing the extra instance-related information which may in some cases be of no use to the user. As discussed above, where multiple items are in the same location, the items may be narrowed down to the appropriate match. Where multiple locations carry the same item, then the item may have the same ratings data associated with each of the locations where the merchant is not relevant to the rating. Alternatively, separate rating data may exist for the item for each merchant so that the merchant is also a factor in the rating. Where the mobile communications device 102 provides the location, then the merchant is known by that location. However, where the mobile communications device 102 provides the item ID, then the ratings server 110 may respond with the ratings data for each of the locations that have the item such that a technique as discussed above may be used to narrow the set of ratings data down to the match.

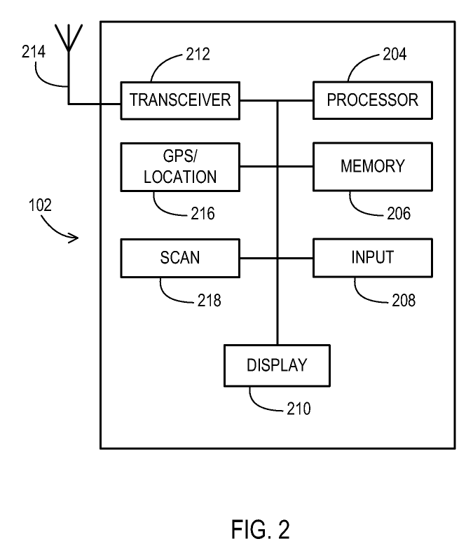

FIG. 2 shows the components of one example of the mobile communications device 102 for interacting with a ratings system, such as the mobile communications network 104. The mobile communications device 102 includes a processor 204, a memory 206, input device 208, and a display device 210 or other output such as an audio speaker. The mobile communications device 102 also includes a transceiver 212 with an antenna 214 for communicating with a wireless endpoint such as a cellular base station and/or directly via peer-to-peer communications with other mobile communications devices.

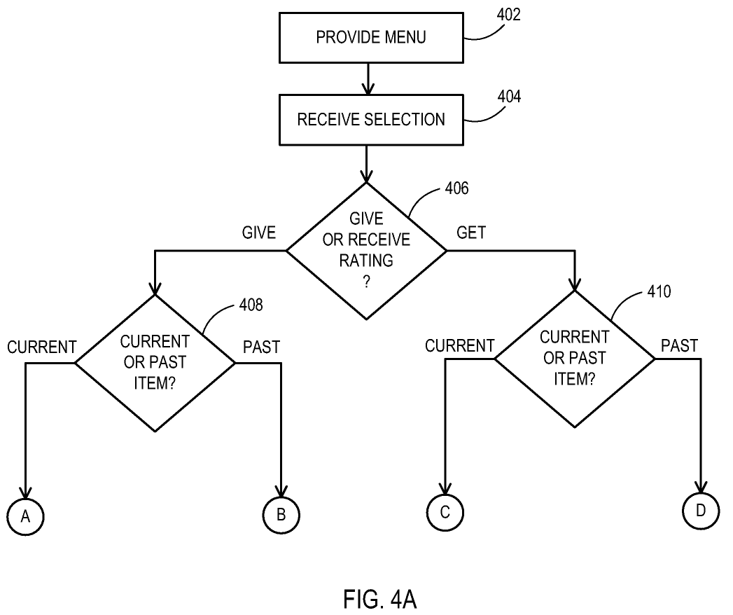

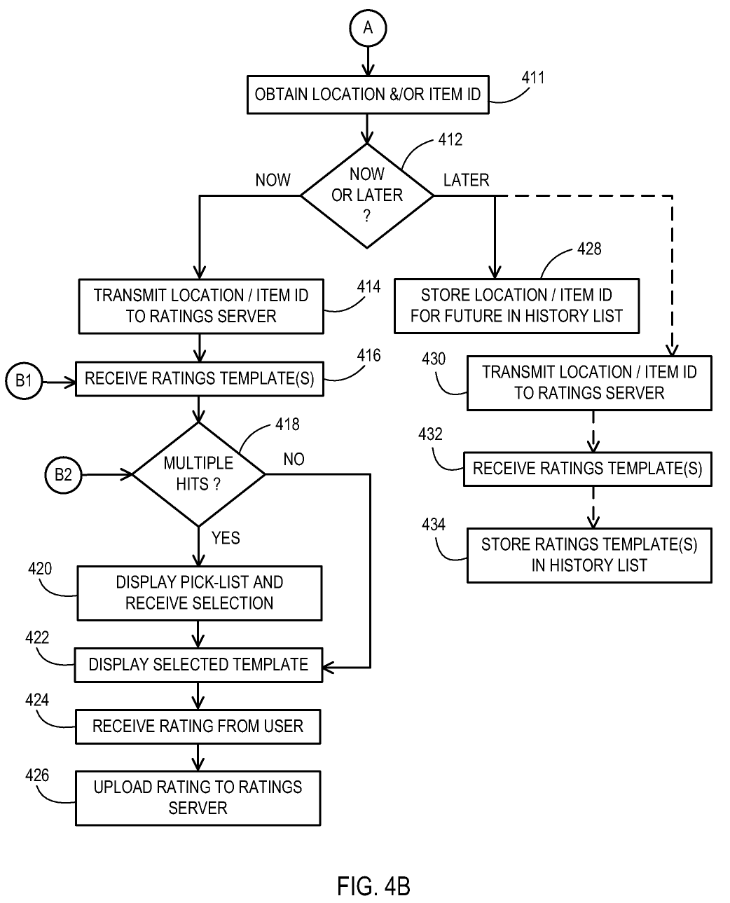

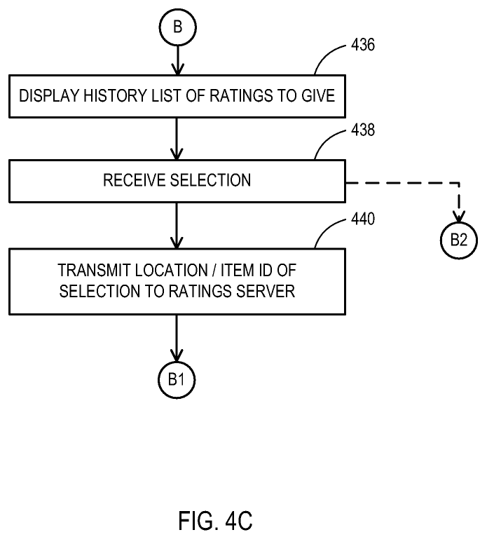

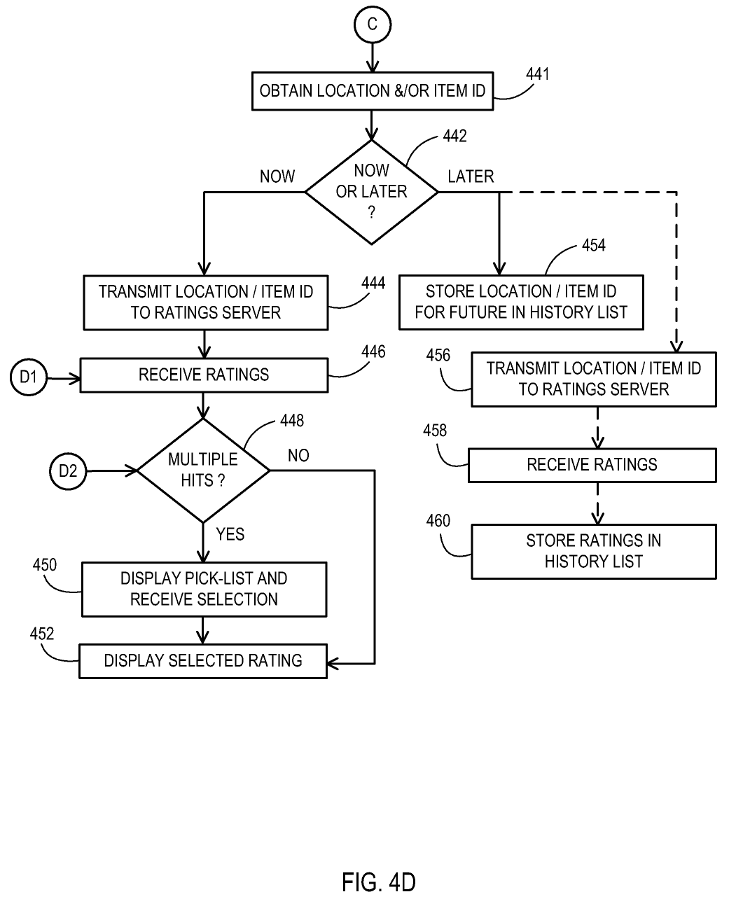

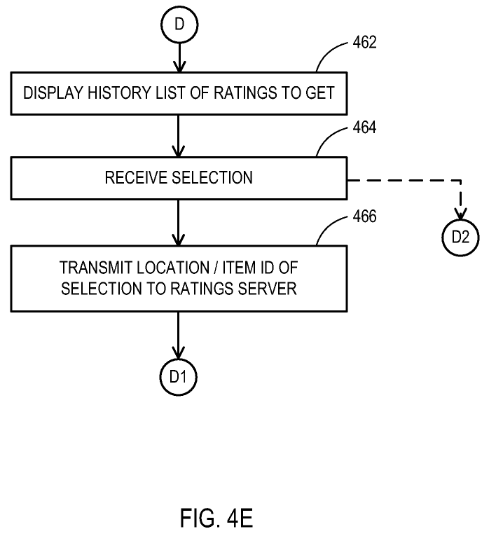

The processor 204 performs actions based on instructions either hard coded into the processor 204 or stored in the memory 206. The logical operations performed are discussed below in relation to FIGS. 4A-4E. The processor 204 may be a dedicated/special purpose processor or a general purpose programmable processor or some combination. The memory 206 may be volatile memory, non-volatile memory, or a combination thereof. The processor 204 and/or memory 206 are examples of computer readable media which store instructions that when performed implement various logical operations. Such computer readable media may include various storage media including electronic, magnetic, and optical storage. Computer readable media may also include communications media, such as wired and wireless connections used to transfer the instructions or send and receive other data messages.

The input device 208 may include a keypad, keyboard, touchscreen, voice recognized input, and so forth. The input device 208 provides data to the processor 204 which acts upon the input to perform requested tasks. The input device 208 may be used to request the ratings or ratings template and to supply the ratings information to the ratings template that has been received.

The output device 210 may include a display screen and/or audio output. The output device 210 may provide an interface allowing the user to make selections to request ratings and to provide necessary input to complete the ratings.

The mobile communications device 102 may also contain one or more rating relevance devices. Rating relevance devices are those that obtain information that specifies what item or items are relevant to the user on the basis of physical proximity of the mobile communications device 102 to items for which rating data exists. The rating relevance devices may include location devices 216 that produce data that identifies the location of the mobile communications device. Examples include GPS receivers, cellular triangulation receivers, and the like. The rating relevance devices may additionally or alternatively include item ID scanners 218 that obtain the item ID of the item 126, either automatically triggered upon coming into physical proximity of the item, for instance when the item comes within a pre-configured range of the device, or manually triggered by the user initiating a scan of the item. Examples include an RFID reader, a bar code reader, a magnetic strip reader, a pattern-detecting camera, and the like.

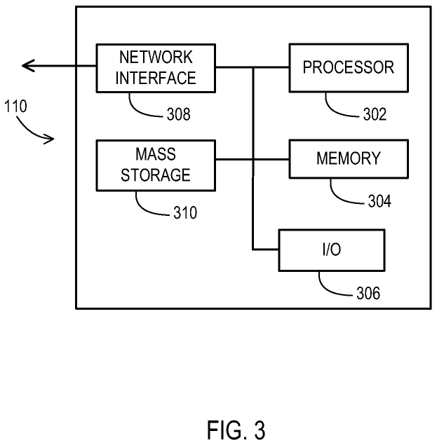

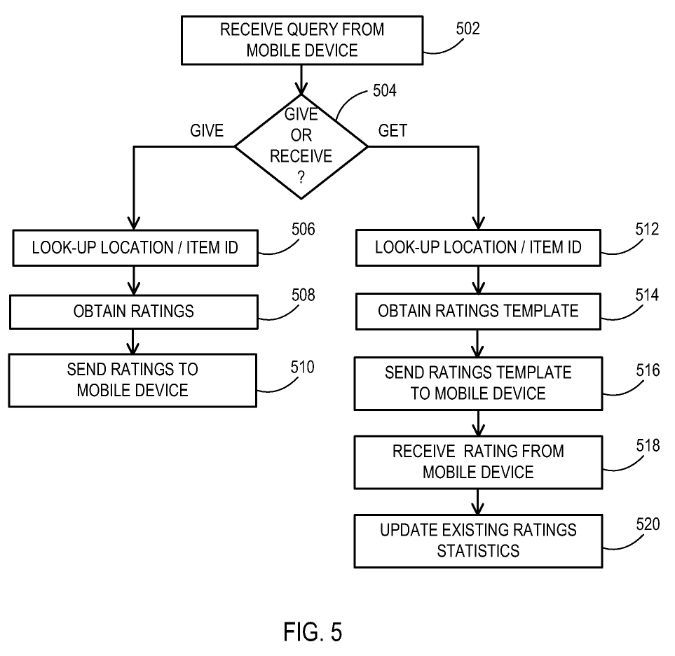

FIG. 3 shows components of an example of the ratings server 110. The ratings server 110 may include the standard components of a server computer including a processor 302, memory 304, input/output devices 306, mass storage 310, and a network interface 308. The processor 302 communicates with external devices including mobile communication device 102 via the network interface 308. The processor 302 processes requests for ratings data by accessing the ratings data from the database and returning the ratings data to the requesting device. The logical operations performed by the processor are discussed below in relation to FIG. 5.

The memory 304 may be volatile or non-volatile or a combination thereof and may store instructions to be performed by the processor 302 when providing the ratings service. As discussed above in relation to the mobile communications device 102, the processor 302 and the memory 304 are example of computer readable media.

The input/output 306 may be used for local operation and management of the ratings server 110. The input/output 306 may include a keyboard, mouse, display, and the like.

The mass storage device 310 may contain applications such as an operating system and a ratings service application. Thus, the processor 302 may access the storage device 310 when implementing the ratings service. The mass storage device 310 is another example of a computer readable medium.

The database 114 of FIG. 1 may be contained within the mass storage device 3 10. As an alternative, the database 114 may be present as network storage, accessible via the network interface 308.

FIGS. 4A-4E illustrate an example of logical operations performed by the mobile communications device 102 when providing and receiving ratings. The logical operations begin at menu operation 402 where the mobile communications device 102 displays or otherwise outputs a menu of options to the user including options for giving or receiving ratings. At selection operation 404, a selection of a menu item made by the user is received. Query operation 406 then detects which menu item was selected. If the option to give a rating was selected, then query operation 408 detects whether the user selected to rate a current item or an item from the past. If the option to get a rating was selected, then query operation 410 detects whether the user selected to get a rating for a current item or get a rating for an item from the past.

The discussion will proceed for the selection to get a rating. If the user selected to get a rating for a current item, then at input operation 411 the mobile communication device 102 obtains the location and/or item ID. The location may be obtained by accessing the output of the location device 216 of the device 102. The item ID may be obtained by accessing the output of the scanner 218, which may produce an output automatically such as for RFID or where the user manually scans a bar code or magnetic strip.

Subsequently, query operation 412 detects whether the user has selected to get a rating now or at some later time. If later, then in one embodiment the mobile communication device 102 stores the current location or the current item ID or both in association with an entry in a ratings history list of the device 102 at storage operation 408. This history list can later be used to find the item to be rated by the user selecting the item from the history list.

In an alternative embodiment as indicated by the dashed lines, the mobile communications device 102, rather than only storing the location and/or item ID, may transmit the location and/or item ID to the ratings server 110 via wireless communications at transmission operation 430. The device 102 may then receive the ratings template(s) in return at reception operation 432. The device 102 then stores the ratings template(s) in association with an entry in a history list of the device 102 at storage operation 434. Where multiple ratings template(s) are received but only a single rating is to be given, the device 102 may implement one of the previously mentioned techniques to narrow the templates down to a single match and then store only that single match. Alternatively, all matches may be stored and one of the techniques is used at a later time when the user selects from the history list in order to provide the rating.

Returning to query operation 412, if the user wishes to give the rating now, then the device 102 transmits the location and/or item ID to the ratings server 110 via wireless communications at transmission operation 414. The device 102 may then receive the ratings template(s) in return at reception operation 416. Query operation 418 detects whether multiple templates are received. If multiple templates are received but only a single rating is to be given, or multiple ratings are to be given one after the other, then one of the techniques are applied to narrow the templates to the single match. In the example shown, the multiple templates are displayed or otherwise outputted in a pick-list and a selection of one is received at display operation 420. The selected template, or the one template that has been received, is displayed or otherwise output at the device 102 for interaction with the user at display operation 422. The user then enters the rating including a value on a scale as well as any textual comments if the template permits at rating operation 424. The device 102 then uploads to the external ratings server 110 via wireless communications the received rating information provided by the user at upload operation 426.

Returning to query operation 408, if the user has selected to give a rating from an item from the past, then the device 102 displays or otherwise outputs the history list of ratings to give at display operation 436. It will be noted that when the device 102 creates a history list of entries, the entries may specify whether they are for future ratings to be given or received or they may not specify such that the user may have either future action performed. The device 102 receives the selection by the user at reception operation 438. Then, for the embodiment where the device 102 has stored the location and/or item ID in memory, the device 102 then transmits the location and/or item ID to the external ratings server 110 at transmission operation 440. Operational flow then proceeds to reception operation 416.

For the alternative embodiment where the device 102 has already transmitted the location and/or item ID and has already received the template(s), then operational flow proceeds to query operation 418.

Returning to query operation 406, the discussion will now proceed with regard to the user wishing to receive a rating. If the user selected to get a rating for a current item, then operational flow proceeds from query operation 410 to input operation 441 where the mobile communication device 102 obtains the location and/or item ID.

Subsequently, query operation 442 detects whether the user has selected to get a rating now or at some later time. If later, then in one embodiment the mobile communication device 102 stores the current location or the current item ID or both in association with an entry in a ratings history list of the device 102 at storage operation 454. This history list can later be used to find the item to get ratings for by the user selecting it from the history list.

In an alternative embodiment as indicated by the dashed lines, the mobile communications device 102, rather than only storing the location and/or item ID, may transmit the location and/or item ID to the ratings server 110 via wireless communications at transmission operation 456. The device 102 may then receive the ratings in return at reception operation 458. The device 102 then stores the ratings in association with an entry in a history list of the device 102 at storage operation 460. Where multiple ratings are received but only a single rating is to be offered to the user, the device 102 may implement one of the previously mentioned techniques to narrow the templates down to a single match and then store only that single match. Alternatively, all matches may be stored and one of the techniques is used at a later time when the user selects from the history list in order to get the rating.

Returning to query operation 442, if the user wishes to give the rating now, then the device 102 transmits the location and/or item ID to the ratings server 110 via wireless communications at transmission operation 444. The device 102 may then receive the ratings in return at reception operation 446. Query operation 448 detects whether multiple ratings are received. If multiple ratings are received but only a single rating is to be provided to the user, or multiple ratings are to be provided one at a time to the user, then one of the techniques are applied to narrow the ratings to the single match. In the example shown, the multiple items for which ratings are available are displayed or otherwise outputted in a pick-list and a selection of one is received at display operation 450. The selected rating, or the one rating that has been received, is displayed or otherwise output at the device 102 at display operation 452.

Returning to query operation 410, if the user has selected to get a rating from an item from the past, then the device 102 displays or otherwise outputs the history list of ratings to give at display operation 462. As discussed above, the history list may be hierarchically organized in terms of time and locations visited so that the user can more easily find the appropriate entry. The device 102 receives the selection by the user at reception operation 464. Then, for the embodiment where the device 102 has stored the location and/or item ID in memory, the device 102 then transmits the location and/or item ID to the external ratings server 110 at transmission operation 466. Operational flow then proceeds to reception operation 446.

For the alternative embodiment where the device 102 has already transmitted the location and/or item ID and has already received the template(s), then operational flow proceeds to query operation 448.

As discussed in relation to FIGS. 4A-4E, the user has initiated the ratings service when wishing to provide or receive ratings of items. However, it will be appreciated that the location of the device 102, and even item IDs for scanners such as RFID, may continually be obtained and even uploaded to a ratings server 110. Thus, the server 110 may initiate the ratings service for a particular device by pushing a ratings pop-up or other interface to the device 102 to request whether the user would like to either provide or receive a rating for a currently item in proximity to the device 102.

Furthermore, the user may wish to initiate a ratings service activity for an item encountered at a location visited in the past even where the user has not taken the initiative to make a ratings menu selection while previously at the location in order to preserve it for future ratings activities. For embodiments where the device 102 is continually keeping a location history trail, the whole trail, or a portion thereof surrounding a relevant time period chosen by the user in lieu of a specific selection from a history list, may be uploaded to the server 110 at transmission operations 440 and/or 446. The server 110 may then respond with multiple ratings or templates but at least narrowed to some extent by the locations within the location trail that has been provided. Thus, the user is able to peruse those items from a pick-list and locate the ratings information for the item truly of interest. Additionally, when the initial pick-list does not contain the desired item the user is seeking, the user may re-specify the relevant time period successively, adjusting the time period and even narrowing extent of the time period until a suitable pick-list selection is obtained.

The discussion of FIGS. 4A-4E has been in relation to the mobile communications device interacting with a centralized server. However, as discussed above, the mobile communications device may additionally or alternatively communicate with other mobile communications devices to exchange ratings data. For example, a user of one mobile communications device may be interested in how others would rate an item and the user may send a request for a rating directly to the mobile communications device of another and then receive a rating from the other mobile communications device. The communications between the mobile communications devices may be peer-to-peer such as through short range communications such as wired connections, Bluetooth® signals, Wi-Fi signals and the like. Furthermore, the mobile communications devices may communicate with one another through the mobile communications network, such as by short message service, wireless application protocol, and the like.

Where the exchange is from mobile communication device to mobile communication device, then rather than sending IDs to the server at operations 414, 430, 444, 456, the IDs are directed to another mobile communications device. Likewise, rather than receiving templates or ratings from the server at operations 416, 432, 446, and 458, the templates or ratings are received from the other mobile communications device.

FIG. 5 illustrates one example of logical operations performed by the external ratings server 110 when the server 110 is involved in the ratings exchange. At reception operation 502, the ratings server receives an incoming request from a mobile communications device 102 over the network 112. At query operation 504, the server 110 determines whether the request is for giving a rating to the device 102 or getting a rating from the device 102.

Where the request is to give a rating to the device 102, the server 110 performs a look-up in the database 114 of the location and/or item ID that has been received to find the one or more sets of associated ratings at look-up operation 506. The server 110 obtains those ratings by reading them from the database 114 at input operation 508 and then sends those ratings to the device 102 through the network 112, and ultimately the wireless connection, at transfer operation 510.

Where the request is to get a rating from the device 102, the server 110 performs a look-up in the database 114 of the location and/or item ID that has been received to find the one or more sets of associated ratings templates at look-up operation 512. The server 110 obtains those ratings templates by reading them from the database 114 at input operation 514 and then sends those ratings to the device 102 through the network 112, and ultimately the wireless connection, at transfer operation 516. The server 110 then receives the return rating information from the device 102 at reception operation 518. The server then updates the existing ratings statistics of the database 520 in accordance with the received ratings information.

Thus, as described herein, a user of a mobile communications device such as a cellular telephone, PDA, and the like may provide and receive ratings for items encountered in various physical locations that the user of the mobile communications device may visit.

While the invention has been particularly shown and described with reference to various exemplary embodiments thereof, it will be understood by those skilled in the art that various other changes in the form and details may be made therein without departing from the spirit and scope of the invention.

What is claimed is:

1. A mobile communications device, comprising:
an output device;
an input device;
a wireless transceiver;
a ratings relevance device that obtains ratings relevance information relevant to an item that is in physical proximity to the mobile communications device at the time the ratings relevance information is obtained; and
a processor configured to provide to an external system the ratings relevance information of the mobile communications device via the wireless transceiver, receive in response to providing the relevance information a request for a rating of the item that is relevant to the relevance information via the wireless transceiver, provide the request on the output device, accept a rating via the input device in response to providing the request, and send the rating via the wireless transceiver to the external system.

2. The mobile communications device of claim 1, wherein the processor is further configured to receive in response to providing the ratings relevance information a rating that is relevant to the relevance information via the wireless transceiver and provide the rating via the output device.

3. The mobile communications device of claim 2, wherein the processor is further configured to accept via the input device a request for a rating by the user and send via the wireless transceiver a request for the rating to the external system, and wherein receiving the rating is further in response to sending the request for the rating to the external system.

4. The mobile communications device of claim 1, wherein the ratings relevance device comprises a location determination device that obtains information describing the location of the mobile communications device.

5. The mobile communications device of claim 4, wherein the location determination device comprises a geonavigational positioning system device.

6. The mobile communications device of claim 1, wherein the ratings relevance device comprises an item identifier scanner.

7. The mobile communications device of claim 6, wherein the item identifier scanner comprises a radio frequency identification tag scanner.

8. The mobile communications device of claim 1, wherein the processor is further configured to store the ratings relevance information in a list, subsequently receive a user input request to rate the item including accepting a user input selection of the ratings relevance information from the list at a time when the mobile communications device is no longer in physical proximity to the item, and then provide the selected ratings relevance information to the external system.

9. The mobile communications device of claim 1, wherein the processor is further configured to store the received request for a rating from the external system in a list, subsequently receive a user input selection of the request to rate the item that has been received from the external system, accept a user input rating, and then provide the rating to the external system.

10. A method of utilizing ratings of items, comprising:
obtaining by a mobile communications device ratings relevance information relevant to an item at a time when the mobile communications device is in physical proximity to the item;
transmitting by the mobile communications device the ratings relevance information to an external system; and
in response to transmitting the ratings relevance information, receiving at the mobile communication device from the external system a rating for the item.

11. The method of claim 10, further comprising receiving at the mobile communication device input by a user that requests the rating and wherein transmitting the ratings relevance information is performed in response to receiving the input that requests the rating.

12. The method of claim 10, wherein the ratings relevance information comprises a description of the location of the mobile communications device.

13. The method of claim 12, further comprising receiving geonavigational positioning system signals at the mobile communication device and determining the location from the geonavigational positioning system signals.

14. The method of claim 10, wherein the ratings relevance information comprises an item identifier.

15. The method of claim 14, further comprising scanning a radio frequency identification tag of the item to obtain the item identifier.

16. The method of claim 10, further comprising:
storing the ratings relevance information in a list at the mobile communications device;
after no longer being in physical proximity to the item, receiving at the mobile communications device a user input request to obtain the rating of the item including receiving a user input selection of the ratings relevance information from the list; and
then providing the ratings relevance information to the external system to obtain the rating.

17. The method of claim 10, further comprising:
storing the received rating in a list at the mobile communications device;
subsequently accepting a user input selection of the received rating at the mobile communications device; and
then providing the rating.

18. A computer readable medium having instructions that perform acts comprising:
obtaining by a mobile communications device ratings relevance information relevant to an item at a time when the mobile communications device is in physical proximity to the item
providing to an external system the ratings relevance information from the mobile communications device;
receiving at the mobile communications device in response to providing the relevance information a request for a rating of the item that is relevant to the ratings relevance information;
providing the request via an output device of the mobile communications device;
accepting a rating via an input device of the mobile communications device in response to providing the request;
sending the rating from the mobile communications device to the external system;
in response to transmitting the ratings relevance information, further receiving at the mobile communication device a rating for the item from the external system; and
providing the rating at the mobile communication device.

19. The computer readable medium of claim 18, wherein the ratings relevance information comprises a description of the location of the mobile communications device.

20. The computer readable medium of claim 18, wherein the ratings relevance information comprises an item identifier.

21. The computer readable medium of claim 18, wherein at least one of receiving a request for the rating of the item from the external system and receiving the rating for the item from the external system occur in response to a user input request at the mobile communications device.

22. The mobile communications device of claim 1, wherein the external system is at least one of a centralized server or a second mobile communications device.

23. The method of claim 10, wherein the external system is at least one of a centralized server or a second mobile communications device.

24. The computer readable medium of claim 18, wherein the external system is at least one of a centralized server or a second mobile communications device.
